(19) United States
(12) Patent Application Publication
(10) Pub. No.: US 2026/0367869 A1
(43) Pub. Date: Nov. 19, 2026

(54) A MEMRISTIVE QUANTUM RANDOM NUMBER GENERATOR

(71) Applicant: IMPERIAL COLLEGE INNOVATIONS LIMITED, London (GB)

(72) Inventors: Muhammad MALIK, London (GB); Christos PAPAVASSILIOU, London (GB)

(21) Appl. No.: 19/471,180

(22) PCT Filed: Mar. 28, 2024
(86) PCT No.: PCT/EP2024/058684

§ 371 Date: Sep. 30, 2025

(30) Foreign Application Priority Data
Mar. 31, 2023 (GB) 2304847.3

(51) Int. Cl. G06F 7/58; G06F 7/02

(52) U.S. Cl. CPC G06F 7/58; G06F 7/02

(57) ABSTRACT

An apparatus for generating random numbers, the apparatus comprising one or more bit stream generators, wherein each bit stream generator comprises: a memristor; a pulse generator configured to: generate a plurality of pulses; and apply the plurality of pulses through the memristor to generate an output comprising a plurality of output pulses; and a comparison means configured to: compare a first sample of the pulsed output with a second sample of the pulsed output; and output, based on the first comparison, information indicative of a randomly generated bit of a random bit stream.

### CROSS-REFERENCE TO RELATED APPLICATIONS

This application is a National Stage Application of PCT/EP2024/058684, filed Mar. 28, 2024, which claims benefit of priority to Application No. 2304747.3, filed Mar. 31, 2023 in Great Britain, and which applications are incorporated herein by reference. To the extent appropriate, a claim of priority is made to each of the above-disclosed applications.

### TECHNICAL FIELD

This disclosure relates to random number generation, and in particular to a system and method for generating random numbers using one or more bit stream generators each comprising memristors.

### BACKGROUND

Methods of random number generation provide random numbers which are advantageous in applications such as machine learning, statistical sampling, computer simulation, cryptography, security, financial services, electronic gaming, and gambling. Applications that benefit from random number generation are typically those that require an unpredictable result.

Currently, systems for generating random numbers may fall into two categories: deterministic; and non-deterministic random number generators. A pseudorandom number generator (PRNG) is deterministic, and a true random number generator (TRNG) is non-deterministic. A random number generated using a PRNG is not truly random because the random number is generated by an initial “seed” value as a result of an algorithm. On the other hand, a random number generated using a TRNG is truly random because this method uses a physical process, or hardware, to generate random numbers from noise signals. It is advantageous to generate a truly random number for various applications. However, existing methods are difficult to scale up because of complex circuitry or a reliance on post-processing to remove bias from generated bits.

Typically, current devices comprise counters and other digital timing devices which can be large in size and increase the complexity of manufacture. These approaches are suboptimal because they are subject to decline over time and require excessive costs. While not common, some known techniques to generate random numbers may make use of memristors. These known techniques may extract randomness from a memristive device using intrusive input signals such as large voltage sweeps to determine whether the memristive device switches states due to the input signal. This method restricts the potential memristive device applications and is likely to degrade the reliability of the memristive device over time, causing failure after a number of cycles. Other examples of known random number generators rely on nanoscale memristors which are fabricated to exhibit exaggerated diffusive behaviour. This again limits the potential memristor applications because of disadvantages in applications such as memory storage.

In summary, existing random number generation techniques are either subject to major degradation of reliability in random number generation over time, comprise complex circuitry, or require post-processing methods to remove bias from the generated bits.

The present invention seeks to address these, and other disadvantages encountered in the prior art, by providing an improved system and method for generating random numbers using one or more bit stream generators.

### SUMMARY

According to an aspect, there is provided a random number generator for generating random numbers comprising one or more bit stream generators, wherein each bit stream generator comprises a memristor; a pulse generator configured to generate pulses and apply at least a first and a second pulse through the memristor; a passive element configured and positioned to store a first analogue signal based on the first pulse; a comparator configured and positioned to compare the first analogue signal with a second analogue signal based on the second pulse, and output information indicative of a randomly generated bit of a random bit stream.

The methods and systems disclosed enable a conversion of an analogue signal into a corresponding stochastic binary sequence for generating a random number by exploiting the stochastic features of nanoscale devices, such as memristors, without significant diffusive characteristics. The memristor may be used to construct a hardware efficient implementation of key building blocks for a stochastic computing applications. Such methods and systems are advantageous in multi-bit memory applications, cryptography, dithering, image processing, and machine learning.

### BRIEF DESCRIPTION OF THE FIGURES

Specific embodiments are now described, by way of example only, with reference to the drawings, in which:

FIG. 1A is an example circuit diagram for generating a random number using a memristor for use on a printed circuit board (PCB) or integrated circuit (IC).

FIG. 1B is an example graph of a response of a memristor to a plurality of stressing and sensing pulses applied to the memristor.

FIG. 2A is an example graph of sensing and stressing pulses applied to a memristor.

FIG. 2B is a zoomed in version of the example graph of FIG. 2A.

FIG. 3 is an example processing diagram for generating a random number using a memristor.

FIG. 4 is an example block diagram for generating a random number using a memristor.

FIG. 5 is an example flow diagram for the method of generating a random number using a memristor.

FIG. 6 is an example system level view of the apparatus and method, wherein Memristive Distribution Generators (MDGs) enable Monte-Carlo sampling of the desired distribution.

FIG. 7 is an example graph of measured input and output of the feedback circuit, as shown in, for example, FIG. 1A, during application of 250k pulses to the memristor.

FIG. 8 is an example graph of distributions of the apparatus output y(n) for three different parameter sets.

FIG. 9 shows example histograms (A-D) of 1-D Regression where 250K hardware generated samples lead to a set of sub-optimal priors (FIGS. 9A and 9C) and after tuning, a set of optimised priors (FIGS. 9B and 9D).

### DETAILED DESCRIPTION

In overview, and without limitation, the application discloses an apparatus for generating random numbers. The apparatus comprises one or more bit stream generators, where each bit stream generator comprises a memristive device, or more specifically, a memristor.

A memristor is an electrical component that limits or regulates a flow of electrical current in a circuit and remembers an amount of charge that has previously flowed through it. When electrically stressed, a memristive device develops defects and/or its internal physical and chemical structure is modified in a way that the device becomes a resistor. Generally, the function of a resistor is to limit or reduce a flow of current by limiting or reducing electron flow and is therefore sensitive to any flow of current. As a result of an applied signal, a resistance of a memristor will change.

A memristor is a two-terminal device and conducts electricity in both directions. The conductivity increases if the memristor's higher polarity terminal is connected to a positive terminal of an applied voltage source (i.e., a plurality of signals of a first polarity are applied to the memristor) and decreases if its lower polarity terminal is connected to the positive terminal of the applied input voltage source (i.e., a plurality of signals with a second polarity are applied to the memristor, where the second polarity is opposite to the first polarity). Conductivity is the measure of how easily electricity flows and electrical resistivity measures how much a material resists the flow of electricity. Conductivity and resistivity are therefore inversely proportional. It follows that in the long term, and on the average, the resistance of a memristor will increase if signals of the first polarity are applied to it and decrease after the application of signals of the second, opposite polarity. However, in short time scales, for example, between 1 and 100 microsecond time scales or less, i.e., in the order of nanoseconds or microseconds, a change in resistance of a memristor is unpredictable and irreproducible. The short time scales are timescales that are much smaller than the rate at which a plurality of pulses are applied to a memristor. After a pulse is applied to the memristor in a short period of time, the resistance of a memristor may increase or decrease unpredictably.

The irreproducibility of the response of a memristor has long been regarded as a defect and an impediment to many applications. However, the present inventors have developed a method which can leverage that irreproducibility to generate truly random numbers. A finite amount of memory is used to represent real numbers on a computer which is equivalent to a fixed number of digits after a decimal point. In general, most represented numbers are approximated to the nearest real number that can be represented given the memory limitation. The distance between an actual real number and the representation of the actual real number may be known as a precision, usually measured in bits. The present method can average values of numbers with arbitrary precision.

In summary, at a very high-level: by comparing a resistance of a memristor (i.e., a pulse response of a memristor) before and shortly after a pulse is applied, a random bit can be generated. The comparison of pulse responses to each other leads to an improvement over the prior art by producing a random analogue signal that is more stable over time, or if using an ADC, producing a bit stream that is more stable over time.

The disclosed apparatus enables random bit generation at a very low hardware cost and has many applications in technology including use in an efficient dither generator for enhancing analogue-to-digital conversion, data classifiers for machine learning, array dither generators for image processing, on-the-fly encryption key generators, and many more applications.

The random numbers generated by the present device satisfy the National Institute of Standards and Technology (NIST) tests for random and pseudorandom number generators for cryptographic applications.

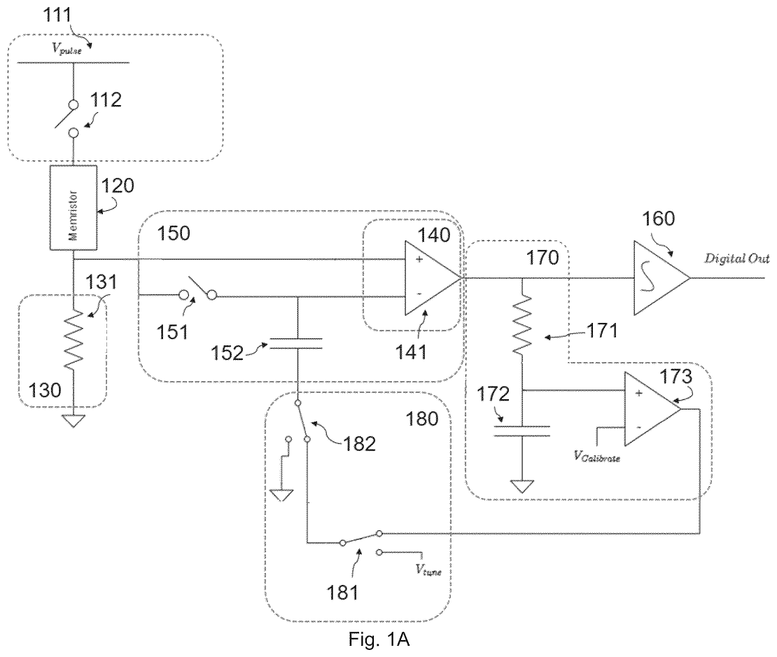

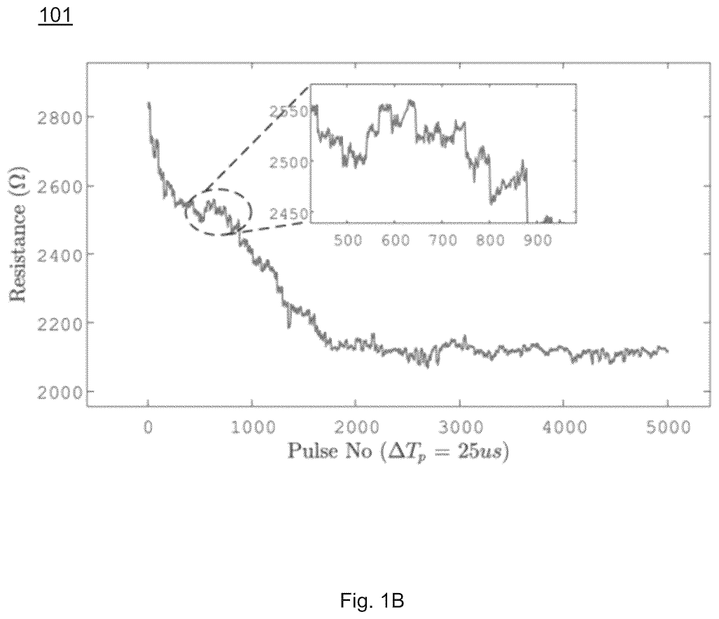

Turning to FIG. 1A, FIG. 1A is circuit diagram depicting an apparatus 100 according to the present disclosure. The apparatus 100 is suitable for, and configured for, generating random numbers, for example for use on a PCB or IC. The apparatus 100 comprises a pulse generator 110, a memristor 120, a sensing means 130, a delaying means 150, a comparison means 140, an analogue-to-digital converter (ADC) 160, a feedback loop 170, and a tuning means 180. Several components of the apparatus 100 are optional, as will be made clear to the skilled person from the following disclosure, including the ADC 160, feedback loop 170, and tuning means 180.

The apparatus 100 comprises the components of a bit stream generator. A bit stream generator generates a bit stream. The present disclosure may include one or more bit stream generators. Each bit stream generator may output information indicative of a plurality of randomly generated bits to form the random bit stream.

The apparatus 100 comprises a pulse generator 110. The pulse generator 110 is configured to generate a plurality of pulses. The pulse generator 110 comprises a voltage or current source 111 and a pulse switch 112. The pulse generator 110 is configured to generate a plurality of pulses, for example, using the voltage (Vpulse) or current (Ipulse) source 111. The plurality of pulses may be voltage or current pulses. The plurality of pulses may be referred to as a sequence of voltage or current pulses. The pulse generator 110 is configured to apply a plurality of pulses through the memristor 120 to generate an output comprising a plurality of output pulses. The pulse generator 110 is further configured to apply the plurality of pulses to the memristor 120 when the pulse switch 112 is closed, i.e., when the voltage or current source 111 is connected to the memristor 120 via the pulse switch 112. When the pulse switch 112 is open, the pulse generator 110 does not apply voltage or current pulses to the memristor 120, i.e., when the voltage or current source 111 is not connected to the memristor 120.

As the plurality of pulses is applied to the memristor 120 in a short period of time, the resistance of the memristor 120 increases or decreases unpredictably to generate the plurality of output pulses. The plurality of output pulses may therefore be considered as a plurality of sensing pulses. The plurality of output pulses includes a first sample of the pulsed output and a second sample of the pulsed output. The first and second samples may be different. It follows that the first and second samples may be considered to be sensing pulses.

To cause the resistance change in the memristor 120, a large pulse or electric field may be generated by the pulse generator 110 to electrically stress the memristor 120 and cause changes to the internal (physical and chemical) structure of the memristor 120 and/or deforms the memristor 120 so that the memristor 120 becomes sensitive to any subsequent current or voltage flowing through. Short pulses may be generated to stress the memristor less and improve reliability of random number generation. The pulse generator may be further configured to generate a plurality of stressing pulses, wherein each sensing pulse is preceded by a stressing pulse. The plurality of stressing pulses may be a plurality of large current or voltage (electric field) pulses. The plurality of stressing pulses apply a large electric field to the memristor, thereby causing stress and enabling the next pulse, i.e., the plurality of pulses responsible for generating the plurality of output pulses, to produce information indicative of a randomly generated bit of a random bit stream.

The plurality of stressing pulses may be preferably narrow voltage pulses. The plurality of stressing pulses may be wide voltage pulses. The plurality of stressing pulses may be shifted voltage pulses. The plurality of stressing pulses may be scaled voltage pulses. In this manner, output noise of the apparatus, for example, an output comprising information indicative of a randomly generated bit of a random bit stream, may be transformed. The transformation may be widening, narrowing, shifting, or scaling, i.e., the amplitude of the plurality of stressing pulses is controlled. Transformations may also be on statistical characteristics of the generated plurality of output pulses or an output random signal, wherein the statistical characteristics may comprise at least one or more of: an average value; an offset; a variance; a distribution; and a bias. For example, larger and wider pules yield an output random signal with a larger amplitude and also alter the relationship between the tuning voltage/capability and the statistical characteristics of the output bitstream. The application of narrow voltage pulses leads to better understood and more reliable behaviour of the memristor 120 when compared with existing methods.

The plurality of pulses may be referred to as a source of stimulus for the memristor 120. The source of stimulus may have controllable parameters, for example, a tuneable voltage source or a tuneable current source. The pulse switch 112 may be referred to as a means of applying the stimulus to the memristor 120. The pulse generator 110 may allow the control of pulse sequence characteristics of the plurality of pulses. This is because the pulse generator 110 may be configured to toggle the pulse switch 112. For example, longer pulses may result in the pulse switch 112 being closed for a longer period of time. Shorter pulses may result in the pulse switch 112 being closed for a shorter period of time. A larger amplitude of the plurality of pulses may be due to a larger voltage (Vpulse) source 111. A smaller amplitude of the plurality of pulses may be due to a smaller voltage (Vpulse) source 111. In addition, the rate at which the pulse switch 112 is toggled may set the timing between the plurality of stressing pulses and the plurality of sensing pulses. The pulse sequence characteristics may be one or more of: impulse amplitude of the plurality of stressing pulses and/or the plurality of sensing pulses; relative amplitudes between the plurality of stressing pulses and the plurality of sensing pulses; relative positions of the plurality of stressing pulses and the plurality of sensing pulses spacing between the plurality of stressing pulses and the plurality of stressing pulses and the plurality of sensing pulses; polarity of the plurality of stressing pulses and/or the plurality of sensing pulses; duration of the plurality of stressing pulses and/or the plurality of sensing pulses; (average) frequency of the plurality of stressing pulses and/or the plurality of sensing pulses; bandwidth of the plurality of stressing pulses and/or the plurality of sensing pulses; shape of the plurality of stressing pulses and/or the plurality of sensing pulses; and duty cycle (i.e., integral or low pass filter output).

The apparatus 100 comprises a memristor 120. The memristor 120 is a nano-scale device and may be referred to as a non-linear two-terminal electrical component relating electric charge and magnetic flux, a nano-scale layer of a metal oxide (e.g., Al, Ti, Sr, Hf), a plurality or sequence of metal oxide layers between two conductors, a solid-state microscale device, a solid-state nanoscale device, an oxide memristor, a phase change resistor, a spintronic logic gate, a ferromagnetic gate, a ferroelectric gate, a single quantum dot, or a multiple quantum dot.

The resistance of the memristor 120 is dependent on a charge that has flowed through the memristor 120, i.e., the stimulus. The memristor 120 does not store energy but does generate a random response from the charge that has flowed through the memristor 120. The random response generated by the memristor 120 exhibits long and short-term plasticity. Plasticity may be described as the ability of a solid material to undergo permanent deformation, i.e., the ability of the memristor 120 to undergo permanent deformation.

When electrically stressed by, for example, a large pulse or electric field from the pulse generator 110, an internal (physical and chemical) structure of the memristor 120 changes and/or deforms so that the memristor 120 becomes sensitive to any subsequent current or voltage flowing through. Therefore, when a plurality of pulses is applied to the memristor 120, the resistance of the memristor 120 changes, resulting in the generation of a random response, a plurality of output pulses. Over a long period of time, the resistance of the memristor 120 increases if signals or charges of a polarity are applied and decreases if signals or charges of an opposite polarity are applied. Over a short period of time, a change in resistance after a plurality of pulses has been applied is unpredictable and irreproducible so the resistance of the memristor 120 may increase or decrease. The random response (e.g., a random bit) may be extracted by comparing the resistance of the memristor 120 before and shortly after a charge or pulse has flowed through the memristor 120.

The plurality of pulses may include the large pulse which can be controlled and changed to output a transformation of noise. The output noise may be wider or narrower, shifted to the left or right, or scaled. Transformations may also be on statistical characteristics of the generated plurality of output pulses or an output random signal, wherein the statistical characteristics may comprise at least one or more of: an average value; an offset; a variance; a distribution; and a bias. For example, larger and wider pules yield an output random signal with a larger amplitude and also alter the relationship between the tuning voltage/capability and the statistical characteristics of the output bitstream.

As described, the memristor 120 generates a random response to the applied plurality of pulses from the pulse generator 110. The plurality of output pulses are based on the (random) response of the memristor through which the plurality of pulses are applied. The response may be a current or a voltage. The plurality of output pulses may be voltage signals or current signals. As the random response from the memristor 120 is slightly different each time a pulse or plurality of pulses is applied by the pulse generator 110, the apparatus is able to extract a truly random number from the memristor 120 using, for example, the sensing means 130.

Each bit stream generator may comprise only one memristor 120. This is advantageous because the use of one memristor 120 results in a more reliable and less complex circuit. Using two or more memristive devices in series may not function as reliably and increases the complexity of the circuit.

The apparatus 100 comprises sensing means 130. The sensing means 130 of FIG. 1A comprises a sense resistor 131. In other embodiments, the sensing means 130 may comprise but is not limited to a current to voltage converter, or a resistor, a transistor, or a Metal Oxide Semiconductor Field Effect Transistor (MOSFET). Each bit stream generator may further comprise a sense resistor 131 configured to sense a variation in the current of the memristor 120 as a voltage. The sensing means 130 is configured to extract the random response from the memristor 120 that has resulted from the applied plurality of pulses from the pulse generator 110, i.e., the stimulus. The random response from the sensing means 130 may be a voltage, a current or another measurable device characteristic. A variation in the current through or voltage across the memristor 120 or the random response of the memristor 120 is sensed by the sensing means 130 as a voltage, a current or another measurable device characteristic. In FIG. 1A, the sensing means 130 comprises a sense resistor 131 so the random response of the memristor 120 is sensed by the sense resistor 131 as a current.

The apparatus 100 comprises comparison means 140. The comparison means 140 may comprise a comparator 141. The comparison means 140 may be a comparator 141. The comparison means 140 may comprise a clocked comparator. The comparison means 140 enables a comparison of the stabilised random signal with a tuneable or controllable threshold via the comparator 141. The comparison means 140 is configured to compare a first sample of the pulsed output with a second sample of the pulsed output, and output, based on the first comparison, information indicative of a randomly generated bit of a random bit stream. The first sample may comprise a sampled plurality of output pulses. The comparison of pulse responses of the first and second samples to each other leads to an improvement over the prior art by producing a random analogue signal that is more stable over time, or if using an ADC, producing a bit stream that is more stable over time.

The present apparatus and method is advantageous because it suppresses the natural drift of the memristor characteristics which make it difficult to generate bits using prior art methods. The comparison means 140 may be further configured to: compare the information indicative of a randomly generated bit of a random bit stream with a comparison threshold or an input threshold; and output, based on the second comparison, tuned information (or a tuned distribution) indicative of a randomly generated bit of a random bit stream. The information indicative of a randomly generated bit of a random bit stream is tuned because there has been a comparison with the comparison threshold or the input threshold.

The comparator 141 may be an analogue voltage mode comparator, or an analogue current mode comparator. The tuneable threshold may introduce more 1s or 0s to the information indicative of a randomly generated bit of a random bit stream using a comparison operation, or for example, a comparator. In this manner, the stochastic characteristics of the bit steam can be tuned.

The apparatus 100 comprises delaying means 150. The delaying means 150 comprises a delaying switch 151, a passive element 152, and the comparator 141. The passive element may comprise at least one of: a capacitor; or an inductor. The passive element 152 may be described as a delaying capacitor 152. The passive element 152 may be configured and positioned to generate the second sample by storing the sampled plurality of output pulses, thereby introducing a delay. The delaying means 150 may be configured to perform analogue polyphase filtering such as differentiation, on the random response from the sensing means 130. The delaying means 150 may comprise an analogue polyphase filter. The analogue polyphase filter may comprise a differentiation means. The delaying means 150 may be configured to compare the first sample of the plurality of pulses with the second sample of the plurality of pulses. The second sample is a delayed version of the first sample. The first sample is stored as an analogue signal by the delaying means 150 and is based on a first current through the memristor 120 during a first period of time. The second sample is an analogue signal and is based on a delayed first sample. Each bit stream generator may further comprise the delaying means 150 configured to generate the second sample by performing computation on the sampled plurality of output pulses. Each bit stream generator may further comprise the delaying means 150 configured to generate the second sample by introducing a delay to the sampled plurality of output pulses.

The delaying means 150 may comprise a comparison means 140. In this manner, an analogue signal of the second sample is compared with the stored analogue signal of the first sample by the comparator 141 to output, based on the comparison, information indicative of a randomly generated bit of a random bit stream. The information indicative of a randomly generated bit of a random bit stream may be one bit and may be referred to as a stabilised random signal. At this stage, the stabilised random signal may be output from the apparatus 100 as an analogue signal.

As the analogue signal is converted into a corresponding stochastic binary sequence for generating a random number using a memristor, it is possible to exploit the stochastic features of nanoscale devices (memristors) without significant diffusive characteristics. This is advantageous in multi-bit memory applications.

The analogue signals of each of the first and second samples may be analogue voltages based on the current through the memristor when the pulses or plurality of pulses of the first and second samples were applied. When the delaying means comprises the comparison means 140, the delaying means 150 may be configured to subtract the second sample from the first sample. The random response of the first sample may be subtracted from the random response of the second sample. The first and second sample may be compared using an analogue delay circuit such as a sample and hold circuit. A sample and hold circuit may be described as an analogue device that samples a voltage of a continuously varying analogue signal and stores its value at a constant level for a specified minimum period of time. A sample and hold circuit may store electric charge in a capacitor e.g., delaying capacitor 152. Indeed, the first sample may be stored as an analogue signal (or voltage) on a sample and hold comparator 141.

The delaying means 150 enables drift of the random response to be counteracted. Drift is low frequency so the analogue polyphase filtering can be considered as a high pass filter. In this manner, frequency components of the analogue signal of lower frequency are excluded.

The apparatus 100 comprises an ADC 160. The ADC 160 is configured to convert the analogue random signal or response or (tuned) information indicative of a randomly generated bit of a random bit stream to a digital random signal. The digital random signal may be referred to as a digital bit stream, a digital random bit stream, a digital bit stream output, a digital output, or a digital random signal output. The digital random signal output comprises information indicative of a randomly generated bit of a random bit stream. The information indicative of a randomly generated bit of a random bit stream may be a one-bit output. The ADC 160 may be a Schmitt trigger or an inverter.

The apparatus 100 comprises a feedback loop 170. The feedback loop 170 comprises a feedback resistor 171, a feedback capacitor 172, and a feedback comparator 173. The feedback loop 170 may be a low pass filter. The feedback loop 170 may low pass filter the random bit stream output from the delaying means 150 and use the output from the feedback loop 170 as the comparison threshold. The comparison threshold may be generated by modifying and feeding back the analogue or digital random output of the delaying means 170 back into the circuit. The feedback loop may be configured to generate the comparison threshold by modifying the tuned information indicative of a randomly generated bit of a random bit stream. The modified tuned information indicative of a randomly generated bit of a random bit stream may be fed back to the delaying means 150 to provide the comparison threshold.

The apparatus 100 comprises tuning means 180. The tuning means 180 comprises a tuning switch 181 and a threshold switch 182. An input of the tuning switch 181 is either a (static) voltage (i.e., user input voltage) or generated by integrating the information indicative of a randomly generated bit of a random bit stream (i.e., a stochastic bit stream) to set a mean value of the stochastic output stream from the feedback loop 170 in a closed loop. The input threshold may be based on the user input voltage. The comparison threshold may be based on the mean value generated by the feedback loop 170. Therefore, the tuning switch 181 either selects the user input voltage or the voltage set by the feedback loop 170 to either route a user supplied threshold (user threshold) or feedback derived from a comparison threshold via the feedback loop 170 (comparison threshold) to the delaying means 150. The threshold switch 182 either routes the input of the running switch 181 (i.e., the user threshold or comparison threshold) or is connected to ground for no tuning. The tuning means 180 allows tuning or setting of the mean value of the output stochastic bit stream.

Each bit stream generator may further comprise a tuning means 180 comprising one or more analogue switches configured to control one or more statistical characteristics of the random bit stream using the comparison threshold or an input threshold. The one or more statistical characteristics may comprise at least one or more of: an average value; an offset; a variance; a distribution; and a bias. This allows an apparatus that can exploit the stochastic features of memristors 120 that do not have significant diffusive characteristics and are optimised for multi-bit memory applications.

The feedback loop 170 and tuning means 180 process and feedback an output of the circuit to aid in stabilising the circuit characteristics. The characteristics to be stabilised are the statistical characteristics of the analogue stream or digital bitstream. Stabilising the circuit characteristics ensures the output remains fixed in the absence of input, i.e., there is a well-defined steady state. Stabilisation occurs at the delaying means 150 by differentiation and by feeding back the average value from the statistical characteristics of the bitstream via the feedback loop 170. For example, a first layer of stabilisation occurs at the delaying means 150, i.e., the differentiation inherently stabilises. A second (and further) layer of stabilisation may occur by feeding back one of the characteristics of the bitstream (e.g., a mean or average value) via the feedback look 170 and tuning means 180 to the delaying means 150.

In use, the apparatus 100 may be used to generate random numbers. In use, the pulse generator 110 generates a plurality of pulses; for example, current or voltage pulses. These pulses are applied to the memristor 120. In an example, a first pulse is applied to the memristor 120. In response to the first pulse being applied to the memristor 120, the memristor 120 generates a first output pulse based on a response to the applied first pulse. For example, in response to a first current or voltage pulse applied to the memristor, the memristor generates a first output pulse. The first output pulse is delayed by the delaying means 150 to generate a second output pulse by introducing a delay to the first output pulse. The first output pulse and second output pulse are compared by the comparison means 140. The information indicative of a randomly generated bit of a random bit stream, an analogue signal, is output from the comparison means. The ADC 160 converts the analogue signal to a digital bit. As further pulses are applied to the memristor 120, further digital bits are output from the ADC 160 and a digital bit stream is formed. The digital bit stream is described as a random number.

The apparatus 100 is advantageous over known systems. In particular, when the memristor 120 is electrically stressed by the plurality of pulses, the memristor 120 develops defects which change the internal resistance. In this manner, the internal physical and chemical structure of the memristor is modified so that the device becomes a resistor. A resistor is sensitive to any subsequent currents passing through it. Therefore, the resistance of the memristor 120 increases or decreases. By comparing the resistance of the memristor 120 before and shortly after a pulse, a random bit can be generated.

To date, the irreproducibility of the random response from the memristor 120 has been thought of as a defect in the field. However, the present disclosure presents a method that uses the irreproducibility of the random response as an advantage to generate truly random numbers and to average values of numbers with arbitrary precision. In this manner, random bit generation is enabled. In addition, the hardware costs are low; at its most basic, the apparatus 100 may comprise a monostable, a comparator, and a memristor. A monostable is a device or circuit having only one stable position or state. A monostable device may be a device which when actuated generates a narrow pulse of well-defined, and optionally controllable, duration.

The present bit stream generator comprised in the apparatus for generating random numbers exploits the inherent cycle-to-cycle variability of nanoscale memristors under constant stimulus. In addition, the circuit diagram 100 of the present system is more hardware efficient than existing systems because the circuit only requires a capacitor and a (clocked) comparator which can be constructed very efficiently using two inverters.

The present bit stream generator may be used as a stochastic neuron for stochastic computing due to tuning or controlling the stochastic bit stream. Using the generated average value, it is possible to code an analogue value into a probabilistic bit, wherein the analogue value is equal to the time-average value of the stochastic bit stream. The hardware realisation of an analogue to probabilistic bit (p-bit) converter can be done using memristors.

Unlike other TRNG memristors that have no control over the statistical characteristics of the outputs, the tuning means 180 in the present disclosure enables the apparatus to tune the mean value of the output bitstream. The mean value of the output bitstream can be set using the tuning means 180 (via Vtune). The mean or average of the output bitstream may approximately equal Sigmoid (Vtune), hence the circuit is not just a TRNG but a stochastic binary neuron because the analogue bitstream has an adjustable mean value. This ability to produce an analogue bit stream with an adjustable mean value is called a stochastic binary neuron and is a building block for emerging computing platforms of stochastic computing.

In this manner, the output stochastic signal mean value can be tuned using Vtune in a non-linear fashion. Therefore, another advantage is that the function connecting Vtune to the mean value of the output bitstream is non-linear and is approximately a sigmoid. The sigmoid is an activation function for neuromorphic computing and machine learning.

Memristors are more reliable than using large voltage sweeps at the input.

The feedback loop 170 is advantageous over post-processing because it regulates DC behaviour. The feedback loop 170 increases power efficiency over post-processing. The op-amp (or the feedback comparator 173) in the feedback loop 170 helps to control average value.

The stochastic bit stream can be used as dither noise in decision-making circuits.

The present disclosure may use differentiation so a bit can be determined using just two samples. Therefore, the apparatus and method is very fast.

In other examples, the memristor response is only compared to a fixed threshold, and therefore may eventually fail or only work with memristors that exhibit large random responses. In the present disclosure, the threshold may be chosen based on the drift of the memristor over time and the difference of two samples is compared to the threshold. The difference of samples is far more stable than a single sample and therefore can be compared to the threshold reliably. This also allows the use of a lower input voltage or lower pulses. Furthermore, the difference operation mathematically amplifies the random response of the memristor and thereby eliminates drift and amplifies random response. This enables the use of memristors with lots of drift that exhibit a minimal stochastic response.

Providing a comparison means which is configured to compare a first sample of the pulsed output with a second sample of the pulsed output, and output, based on the first comparison, information indicative of a randomly generated bit of a random bit stream is advantageous, in particular since it suppresses the natural drift of the memristor characteristics which make it difficult to generate bits from prior art methods.

The present disclosure benefits from speed. Some examples use counting based methods i.e., by integrating the memristor response for a fixed time and determine whether the memristor response is different each time. The present disclosure differentiates, and therefore has improved speed. A bit can be determined based on two samples only.

FIG. 1B is a diagram 101 showing the response of a memristor to a series or plurality of stressing and sensing pulses.

The randomness in the response of the memristor from pulse to pulse is evident in the zoomed in portion of the diagram 101. In FIG. 1B, the randomness in the response is exhibited in terms of resistance (i.e., current divided by a voltage magnitude used to stress or sense).

FIG. 1B shows the pulse number from 0 to 5000 pulses (when change in time, ΔTₚ, is equal to 25 us) on the x-axis, and resistance in Ohms from 2000 to 2800 Ohms. The resistance is the response of the memristor and the pulse number, or number of pulses, represents in the plurality of stressing and sensing pulses.

The zoomed in portion of the diagram 101 shows the graph when the resistance is 2450 to 2550 Ohms from pulse 400 to 1000.

The prior art uses a fixed threshold centred around some local random section, for example, a threshold of 2500 Ohms from pulse 500 to 900. If the response exceeds the threshold, the response is labelled a ‘1’ and if the response does not exceed the threshold, the response is labelled a ‘0’. The full memristor response (current and hence resistance) drifts over time using this method, which invalidates the use of a fixed threshold because eventually the resistance may be permanently below the chosen threshold resulting in permanent 1s or 0s.

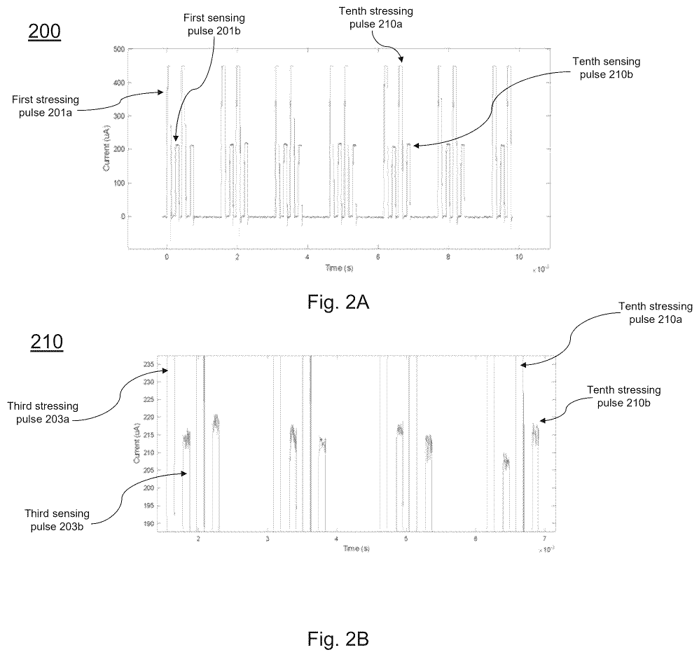

The present disclosure, as shown in FIG. 1B, compares one pulse to the next as illustrated in FIGS. 2A and 2B. Hence, the “threshold” is adaptive and derived from the pulses themselves. This comparison allows a more robust solution in the presence of drift. Mathematically, the present disclosure is high pass filtering which removes the low frequency content, i.e., the drift component.

This is a way of stabilising the circuit characteristics to ensure the output remains fixed in the absence of input, i.e., there is a well-defined steady state. Stabilisation occurs at the delaying means 150 by differentiation and by feeding back the average value from the statistical characteristics of the bitstream via the feedback loop 170. As described in relation to FIG. 1A, the first layer of stabilisation occurs at the delaying means 150, i.e., the differentiation inherently stabilises. The second (and further) layer of stabilisation may occur by feeding back one of the characteristics of the bitstream (e.g., a mean or average value) via the feedback look 170 and tuning means 180 to the delaying means 150.

The advantages are the same as described above in relation to FIG. 1A.

Turning to FIGS. 2A and 2B, FIGS. 2A and 2B are pulse diagrams 200, 210 depicting the input plurality of pulses according to the present disclosure.

The plurality of pulses in FIGS. 2A and 2B are current pulses. The pulse generator 110 is configured to apply the plurality of pulses to the memristor 120 when the pulse switch 112 is closed. When the pulse switch 112 is open, the pulse generator 110 does not apply voltage or current pulses to the memristor 120.

FIG. 2A is a pulse diagram, showing time between 0.001 and 0.01 seconds on the x-axis, and current between approximately −100 and 450 micro-Amps on the y-axis. A measured trace is shown with large pulses followed by a random sequence of pulses. Each large pulse is followed by a random pulse e.g., a first or second sample. Referring to the other Figures, the large pulse is described as a stressing pulse and the random pulse is described as a sensing pulse or an output pulse. As previously described, when electrically stressed by a large pulse or electric field from the pulse generator 110, an internal structure of the memristor 120 deforms so that the memristor 120 becomes sensitive to any subsequent current flowing through. Therefore, when a plurality of pulses is applied to the memristor 120, the resistance of the memristor 120 changes, resulting in the generation of a random response. This is shown in FIG. 2A, as a large pulse (first stressing pulse 201a, . . . , third stressing pulse 203a, . . . , tenth stressing pulse 210a, . . . ), e.g., the electrically stressing pulse at around 450 micro-Amps, is applied to the memristor, and a random response is generated, e.g., the smaller pulse at around 200 micro-Amps, by measuring and comparing the smaller, random pulses (first sensing pulse 201b, . . . , third sensing pulse 203b, . . . , tenth stressing pulse 210b, . . . ).

If the large pulse is great, the distribution widens and there is greater variation in smaller pulse height.

FIG. 2B is a zoomed version of the pulse diagram of FIG. 2A showing time between 0.001 and 0.007 seconds on the x-axis, and current between approximately 187 to 238 micro-Amps on the y-axis. From the sensing pulses (smaller pulses) 203b, . . . , 210b, it is apparent that the random sequence output from the apparatus is 1 0 0 1 due to measuring and comparing the sensing pulses 203b, . . . , 210b. As described in relation to the apparatus Figures, a delaying means 150 may be configured to subtract the second sample from the first sample.

The sensing and stressing pulses can be considered in pairs, for example in relation to the sensing pulses, the pairs are the first and second sensing pulses, the third and fourth sensing pulses, the fifth and sixth sensing pulses, the seventh and eighth sensing pulses, and the ninth and tenth sensing pulses. If the first pulse in the pair is smaller than the second pulse in the pair, a 1 is allocated to the bit. Otherwise, a 0 is allocated. Looking to FIG. 2B, the first pair (the third and fourth sensing pulses) is a 1 and the fourth pair (the ninth and tenth sensing pulses) is 1. The other two pairs are 0 because the first pulse in the pair is not smaller than the second pulse in the pair. This is an arbitrary definition and may be considered in reverse.

In general, if pairs of sensing pulses are considered, then the instances where the first sensing pulse is smaller than the second sensing pulse is a 1. In all other cases, it is 0. As an example, when using a generic analogue polyphase filter and delay, a bit may be produced by considering some other combination of sensing pulses.

Choosing “1” or “0” may be thought of as subtracting P (N+1)−P(N) from N and if >0, it is a “1”. Otherwise, it is a “0” for every pair.

The output noise of the apparatus, for example, an output comprising information indicative of a randomly generated bit of a random bit stream, may be transformed if the plurality of stressing pulses are input in different ways. The plurality of stressing pulses in FIGS. 2A and 2B are narrow voltage pulses. The application of narrow voltage pulses leads to better understood and more reliable behaviour of the memristor 120 when compared with existing methods. Furthermore, the hardware to apply pulses to memristors and to read the memristor response to such pulses is present in mainstream memristor integrated circuits where the memristor is being used as a storage device.

The plurality of stressing and sensing pulses are simple to produce as, in a simple embodiment, just a switch is required. Using this apparatus and method is less intrusive and destructive than generating large and sustained inputs because the plurality of stressing and sensing pulses of the present disclosure have less input. Using a plurality of stressing and sensing pulses allows very fast number generation due to the nature of the pulses and a random response from memristors that do not exhibit a pronounced random response. For example, some applications rely on memristor TRNG that emit random noise spontaneously without inputting pulses to the memristor.

In the present disclosure, a diverse range of memristors may be used because the method and apparatus is applicable to a large number of memristors, for example, both diffusive and non-diffusive may be used.

Generally, input pulses are narrow to avoid saturating the memristor's resistance to its limiting low and high resistance state. Lower voltage pulses are used to read the resistive state to minimise the effect of the reading operation on the resistive state. However, the width and amplitude of the input pulses are not critical because of the required unpredictable state of the memristor.

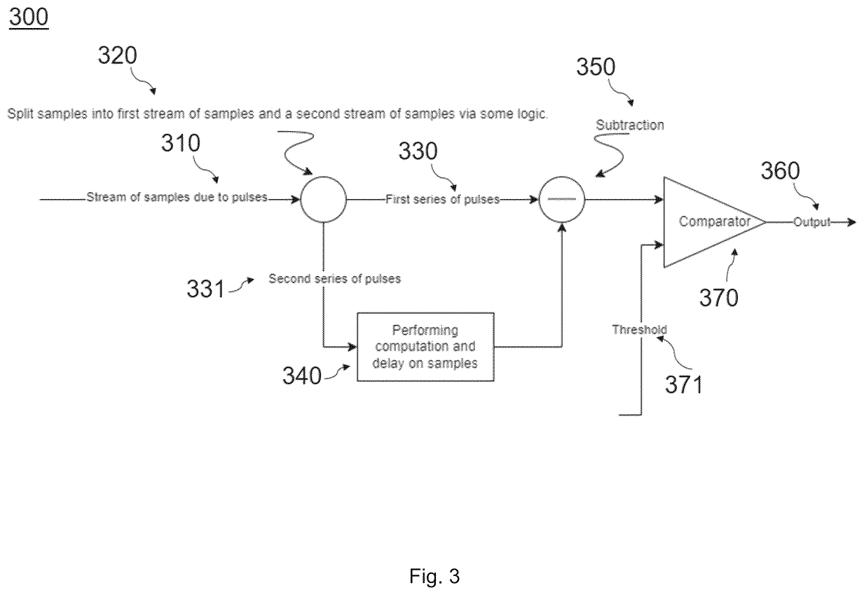

FIG. 3 is a simplified schematic diagram depicting an apparatus 300. Apparatus 300 may be a bit stream generator. While FIG. 1A is a specific example of an apparatus 100 according to the present disclosure, FIG. 3 is a more general example of such an apparatus. In other words, the apparatus depicted in FIG. 1A can be thought of as a specific example of the type of apparatus 300 depicted in FIG. 3.

The apparatus 300 is suitable for generating random numbers according to the present disclosure. The apparatus 300 comprises an input stream of samples due to a plurality of pulses 310, a means 320 of splitting the input stream of samples into a first stream of samples and a second stream of samples via logic, the means 320 capable of and configured to produce a first series of pulses 330 based on the first stream of samples and a second series of pulses 331 based on the second stream of samples, a means 340 for performing computation and delay on the second series of pulses, the means 340 capable of and configured to produce a delayed second series of pulses based on the second series of pulses 331, a means 350 of subtracting the first series of pulses 330 from the delayed second series of pulses capable of and configured to output an output 360 comprising information indicative of a randomly generated bit of a random bit stream, a means 370 of comparison comprised by the means 350 and capable of and configured to compare the information indicative of a randomly generated bit of a random bit stream with a threshold 371, the threshold 371, and the output.

Several components of the apparatus 300 are optional, as will be made clear to the skilled person from the following disclosure, including the threshold 371. The apparatus 300 may additionally comprise feedback. When the threshold 371 is a comparison threshold, the feedback aids in generating the comparison threshold by modifying and feeding back the output 360. The threshold 371 may also be an input threshold.

The stream of samples due to a plurality of pulses 310 relates to the pulse generator 110 of FIG. 1A. At this stage, a plurality of pulses is generated and is referred to as a stream of samples (of pulses).

The means 320 of splitting the stream of samples into a first stream of samples and a second stream of samples via logic could be performed by, for example, the pulse generator 110 of FIG. 1A. The first and second streams of samples are used when comparing a first (stream of) sample(s) with a second (stream of) samples, based on the first series of pulses 330 and the second series of pulses 331, respectively. Logic may be used to split the first and second sample instead of a pulse switch 112.

The means 340 for performing computation and delay on the second series of pulses to produce a delayed second series of pulses based on the second series of pulses 331 could be performed by, for example, the delaying means 150 of FIG. 1A. In this manner, computation may be performed on the second series of pulses 331 to delay the second series of pulses 331 and enable the comparison of the first series of pulses 331 with the delayed second series of pulses.

The means 350 of subtracting the first series of pulses from the delayed second series of pulses could be performed by, for example, delaying means 150 to generate a (stabilised) random signal or random series of pulses. The means 350 of subtracting the first series of pulses from the delayed second series of pulses could perform the function of outputting the analogue random signal of FIG. 1A.

The means 370 of comparison and the threshold 371 could be performed by, for example, the comparison means 140, feedback loop 170, and tuning means 180 of FIG. 1A. The means 370 of comparison and threshold 371 enable a comparison of the random signal or series of pulses with a tuneable or controllable threshold via a comparator. In this manner, the stochastic characteristics of the bit steam can be tuned. This allows tuning or setting of the mean value of the output stochastic bit.

The output 360 could be performed by, for example, the ADC 160 of FIG. 1A and outputs the random bit or bit stream digitally.

The skilled person would appreciate that the hardware and functionality depicted in FIG. 3 can be implemented in several ways. One example of such an implementation is depicted in FIG. 1A.

The advantages are the same as described above in relation to FIG. 1A.

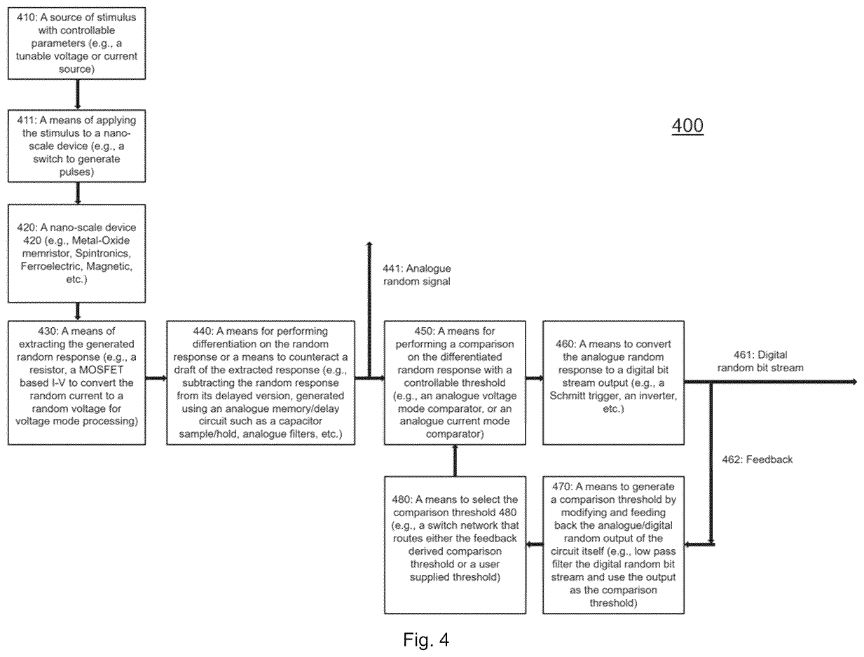

Turning to FIG. 4, FIG. 4 is a block diagram depicting an apparatus 400 according to the present disclosure for generating a random number using a memristor. The block diagram contains comments on the function of each depicted hardware components to promote understanding. The depicted apparatus 400 is particular useful for generating a random number for use on a PCB or IC, and the block diagram 400 comprises elements which may be used to generate random numbers on a PCB or IC. The elements relate to the components of FIG. 1A and will be described accordingly. The arrows in FIG. 4 depict the flow of information within hardware 400.

The block diagram 400 comprises a source of stimulus 410 with controllable parameters (e.g., a tuneable voltage or current source), a means 411 of applying the stimulus to a nano-scale device (e.g., a switch to generate pulses), the nano-scale device 420 (e.g., Metal-Oxide memristor, Spintronics, Ferroelectric, Magnetic, etc.), a means 430 of extracting the generated random response (e.g., a resistor, a MOSFET based I-V to convert the random current to a random voltage for voltage mode processing), a means 440 for performing differentiation on the random response or a means 440 to counteract a draft of the extracted response (e.g., subtracting the random response from its delayed version, generated using an analogue memory/delay circuit such as a capacitor sample/hold, analogue filters, etc.), a means 450 for performing a comparison on the differentiated random response with a controllable threshold (e.g., an analogue voltage mode comparator, or an analogue current mode comparator), a means 460 to convert the analogue random response to a digital bit stream output (e.g., a Schmitt trigger, an inverter, etc.), a means 470 to generate a comparison threshold by modifying and feeding back the analogue/digital random output of the circuit itself (e.g., low pass filter the digital random bit stream and use the output as the comparison threshold), and a means 480 to select the comparison threshold (e.g., a switch network that routes either the feedback derived comparison threshold or a user supplied threshold).

The source of stimulus 410 and means 411 of applying the stimulus could be performed by, for example, the pulse generator 110 of FIG. 1A. The nano-scale device 420 relates to the memristor 120 of FIG. 1A. The means 430 of extracting the generated random response could be performed by, for example, the sensing means 130 of FIG. 1A. The means 440 for performing differentiation could be performed by, for example, the delaying means 150 of FIG. 1A. An analogue random signal 441 may be output from the means 440 for performing differentiation. The means 450 for performing a comparison could be performed by, for example, the comparison means 140 of FIG. 1A. The means 460 to convert could be performed by, for example, the ADC 160 of FIG. 1A. A digital random bit stream 461 may be output from the means 460 to convert. Feedback 462 may be sent from the output of the means 460 to convert to the means 470 to generate a comparison threshold. The means 470 to generate a comparison threshold could be performed by, for example, the feedback loop 170 of FIG. 1A. The means 480 to select the comparison threshold could be performed by, for example, the tuning means 180 of FIG. 1A.

Several components of the apparatus 400 are optional, as will be made clear to the skilled person from the following disclosure, including the digital random bit stream 461, the feedback 462, and the means 460 to convert, means 470 to generate a comparison threshold, and means 480 to select the comparison threshold.

The source of stimulus 410 and means 450 for performing a comparison may be equal to a means to alter the statistical characteristic of the generated random signal.

The means 470 to generate a comparison threshold and means 480 to select the comparison threshold may be equal to a means to process and feedback the circuits output to stabilise its characteristics.

The advantages are the same as described above in relation to FIG. 1A.

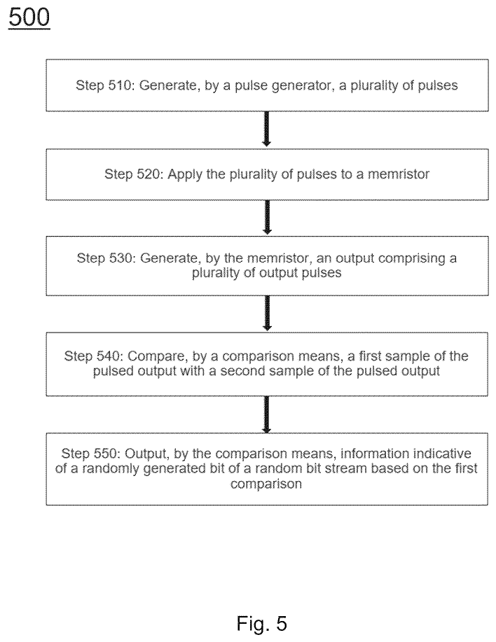

Turning to FIG. 5, FIG. 5 is a flow diagram depicting a method 500 for generating random numbers according to the present disclosure. The method is suitable for being performed, for example, by the apparatus 100, 300, 400.

At step 510, a pulse generator generates a plurality of pulses. For example, the pulse generator generates the plurality of pulses using a voltage or current source. The plurality of pulses may be referred to as a source of stimulus for a memristor. For example, with reference to FIG. 1A, pulse generator 110 may generate these pulses.

At step 520, the plurality of pulses is applied to the memristor. The applied pulses are also described as the stimulus.

At step 530, the memristor generates an output comprising a plurality of output pulses. For example, a random response (e.g., a random bit) may be extracted by comparing the resistance of the memristor before and shortly after the stimulus has flowed through the memristor. The resistance of the memristor is dependent on a charge that has flowed through the memristor, i.e., the stimulus. The plurality of output pulses may be based on a response of the memristor through which the plurality of pulses are applied. The response of the memristor may be a voltage. The method may further comprise sensing, by a sense resistor, a variation in the current of the memristor as a voltage.

At step 540, a comparison means compares a first sample of the pulsed output with a second sample of the pulsed output. For example, an analogue signal of the second sample is compared with a stored analogue signal of the first sample by a comparator. The first sample may comprise a sampled plurality of output pulses. The method may further comprise generating, by a delaying means, the second sample by introducing a delay to the sampled plurality of output pulses. The method may further comprise generating, by a delaying means, the second sample by performing computation on the sampled plurality of output pulses. The method may further comprise storing, by the delaying means, the sampled plurality of output pulses to generate the second sample and introduce a or the delay to the sampled plurality of output pulses. The delaying means may comprise at least one or more of: the comparison means; an analogue polyphase filter or a differentiation means; and a passive element. The passive element may be a capacitor. When the delaying means comprises the comparison means, the method further comprises subtracting, by the delaying means, the second sample by the first sample.

At step 550, the comparison means outputs information indicative of a randomly generated bit of a random bit stream based on the comparison. For example, the comparator outputs, based on the first comparison, information indicative of a randomly generated bit of a random bit stream. The information indicative of a randomly generated bit of a random bit stream may be one bit or a bit stream and may be referred to as a stabilised random signal. The method may further comprise comparing, by the comparison means, the information indicative of a randomly generated bit of a random bit stream with a comparison threshold; and outputting, by the comparison means, tuned information indicative of a randomly generated bit of a random bit stream based on the second comparison The comparison means comprises a clocked comparator. The method may further comprise generating the comparison threshold by modifying, by a feedback loop, the tuned information indicative of a randomly generated bit of a random bit stream.

The method may further comprise controlling, by one or more analogue switches, one or more statistical characteristics of the random bit stream using the comparison threshold or an input threshold. The one or more statistical characteristics may comprise at least one or more of: an average value; an offset; a variance; a distribution; and a bias.

Optionally, when the information indicative of a randomly generated bit of a random bit stream is output from the comparison means, i.e., an analogue signal, the method may further comprise converting the analogue signal to a digital bit. As further pulses are applied to the memristor 120, further digital bits are output from the ADC 160 and a digital bit stream (or random bit stream) is formed. The digital bit stream is described as a random number. The random number may be a chosen length of the random bit stream.

The advantages are the same as described above in relation to FIG. 1A.

It will be understood that the above description of specific embodiments is by way of example only and is not intended to limit the scope of the present disclosure. Many modifications of the described embodiments, some of which are now described, are envisaged, and intended to be within the scope of the present disclosure.

For example, while the majority of the apparatuses described above and depicted in the Figures comprise a single comparator, it should be appreciated that the comparison means described herein may comprise two or more comparators. Two or more comparators may be used to implement multi-level (e.g., ternary, quaternary, etc.) logic.

For example, while the majority of the apparatuses described above and depicted in the Figures comprise a single bit stream generator, it should be appreciated that the apparatus described herein may comprise a plurality of bit stream generators, wherein each of the plurality of bit stream generators is connected together.

The system may be described in terms of cryptography. The following applications result from the capability of tuning the statistical characteristics, where the control/tuning capability is kept at a fixed value. This enables the system to be viewed as a digital source of hardware randomness. Numerous applications in classical cryptography and decentralised cryptography for Web3.0 may be considered. Some examples may include security key generation for classical encryption algorithms, hardware ID generation for electronic wallets (e.g., the Ledger device), generating random test vectors efficiently for probabilistic interactive proof networks in decentralised cryptography, zero-knowledge proofs, generating seeds for digital PRNG, a hardware backed Verifiable Random Function service for Web3.0, on-the-fly encryption key generators, and Physically Unclonable Function.

The system may be described in terms of dithering and control. The following applications result from the capability of tuning the statistical characteristics, where the control/tuning capability is kept at a fixed value. This enables the system to be viewed as hardware that generates a random analogue signal. Some examples may include control of circuits such as amplifiers, power electronics, and ADCs, modulating amplifiers and analogue to digital converters (Sigma Delta), dither generators for enhancing ADC, array dither generators for image processing, and power electronics control loop dithering.

The system may be described in terms of machine learning and AI. The following applications result from the capability of tuning the statistical, for example mean and variance, characteristics of the random output, and revolve around the ability of the present system to form networks. The system may form networks because the output of one unit may be connected to input of an adjacent unit to construct machine learning systems in hardware. Some examples may include Bayesian belief networks, Hopfield networks, reservoir computing platforms, inverse problem solvers, Boltzmann machine, Ising machine, stochastic computing, quantum simulations, stochastic binary neuron, hardware analogue optimiser, simulated annealing, data classifiers for machine learning, and adiabatic computing.

Parts of the disclosed method and system may be implemented using machine learning and AI. In particular and as described above in relation to FIG. 4, the analogue random signal 441 output from the means 440 for performing differentiation may be used for AI computation. In such systems, the apparatus may generate tuneable distributions in hardware for Bayesian inference and Monte-Carlo sampling. As such, the information indicative of a randomly generated bit of a random bit stream is used for Bayesian inference and Monte-Carlo sampling.

The stochasticity of memristors can be described from various perspectives: as a stochastic distribution imposed on the threshold voltage to model stochastic I-V sweeps, as random Telegrapher Noise under a constant read pulse, as a distribution of conductance under repeated set/reset, or as a pulse-to-pulse variation under a constant pulsed stimulus.

Indeed, when the stochasticity of a memristor is described as pulse-to-pulse variation under a constant pulsed stimulus, a memristor response on the shortest of timescales with high speed applications is typically represented. In this domain, the stochastic behaviour can be modelled as an absorbing Markov chain, settling to some equilibrium distribution of conductance states. A Markov chain can be described as a stochastic model describing a sequence of possible events in which the probability of each event depends only on the state attained in the previous event. Hence, a memristor under constant pulsed stimulus can be thought of as producing random samples from some unknown distribution, as described throughout.

Storing model parameters in the conductance's of memristor arrays is an energy and area efficient method, poised for upcoming computing paradigms. However, this is challenging due to memristor variability, from one read cycle to another, as it introduces uncertainty in a parameter intended to be represented by a conductance. If the parameters being stored have some inherent distribution and uncertainty, it is conceivable to tune the conductance distributions of the memristors to mirror the distribution of the parameters. By aligning a conductance distribution relating to memristor conductance with a parameter distribution relating to the described parameters, a variability of the memristor conductance serves as a natural representation of the underlying uncertainty in the parameters and is no longer deemed a source of error.

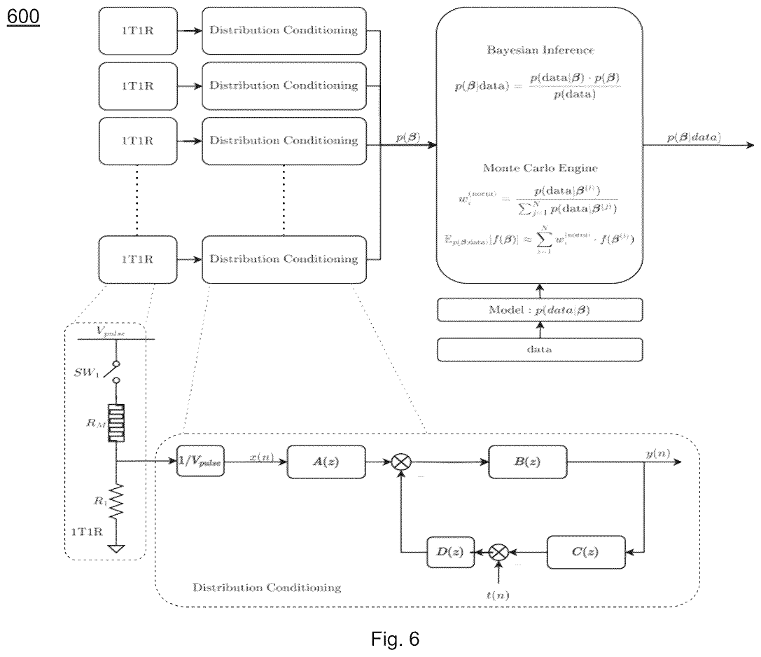

Precisely tuning memristors to a desired conductance distribution is difficult due to coupling of the distributions tuned moments. It is, however, possible in the present application as the apparatus uses a memristor and exploits the cycle-to-cycle conductance variability of the memristor to create stable distributions with tunable mean values and standard deviations. In some implementations, the distributions do not exactly match the intended complex parameter distribution, so they are used as tunable proposal distributions for performing adaptive Monte-Carlo sampling of the intended parameter distribution. This can be seen in FIG. 6.

The apparatus is based on the cycle-to-cycle variability of a memristor 120 being observed as a random change in (read) current at a sensing means (e.g. sensing means 130), upon the application of a (read) pulse (from e.g., a pulse generator 110), wherein the noise distribution is processed by an analog circuit (e.g., the apparatus 100) consisting of a sample and hold differentiator (e.g., the delaying means 150), a comparator (e.g., the comparison means 140) and a feedback circuit (e.g., the feedback loop 170 and/or the tuning means 180). In this example, the sense resistor senses a variation in the current of the memristor as a voltage. The analogue circuit stabilises the noise distributions of the read current by eliminating or preventing a slow, low frequency drift component and by amplifying a high frequency broadband noise. In FIG. 6, a circuit 600 based on the described apparatus can be implemented in either a digital (i.e., output as digital random bit stream 461 through use of an ADC e.g., the ADC 160) or sampled analog domain (i.e., as analogue random signal 441), and is used for AI computation.

This apparatus is seen in circuit 600 where the memristor and “Distribution Conditioning” circuit is seen. The circuit 600 operates as follows, the switch SW1 applies a voltage source Vₚᵤₗₛₑ to the memristor R_{M} every t=nT seconds where T is the sampling period. This generates a voltage pulse sample that is proportional to the memristor random current response across a current sense resistor R₁. A proceeding gain block

$$\frac{1}{{V}_{pulse}} ,$$

or a first block, scales this to an equivalent random conductance sequence x(n)·x(n) as a low frequency drift component that is preferably removed (or eliminated) to ensure a stable distribution. This is achieved via a second block A(z)=1−z⁻¹.

To ensure the resulting sequence out of A(z) has a well-defined mean value, the feedback structure consisting of a third block B(z)=b, a fourth block

$$C ( z ) = \frac{{c}_{0}}{1 - {c}_{1} {z}^{- 1}}$$

and, a fifth block D(z)=d is used. The reference mean t(n) that is desired from the output sequence y(n), is injected between the fourth and fifth blocks.

The z-transform of the output in terms of the inputs (X(n) and T(z)) and circuit blocks (A(z), B(z), C(z) and D(z)) is shown in Equation 1:

$$Y ( z ) = X ( z ) \cdot \frac{b \cdot ( {z}^{2} - ( 1 + {c}_{1} ) \cdot z + {c}_{1} )}{( b \cdot d \cdot {c}_{0} + 1 ) \cdot {z}^{2} - {c}_{1} \cdot z} + T ( z ) \cdot \frac{b \cdot d \cdot ( z - {c}_{1} )}{( b \cdot d \cdot {c}_{0} + 1 ) \cdot {z}^{2} - {c}_{1} \cdot z} \qquad ( Equation 1 )$$

Any memristors, such as Pt, TiO₂, and/or Pt memristors may be used. The feedback circuit (representing, for example, feedback loop 170 and/or tuning means 180) may be implemented in the digital domain, in, for example, a microcontroller. The pulses may be generated and controlled by a custom memristor characterisation platform. The platform may apply the pulses, measure the resulting random current response, process the samples in the feedback circuit and transmit the output of the circuit, via a serial port, to a computer for analysis. The computer may comprise a Python script.

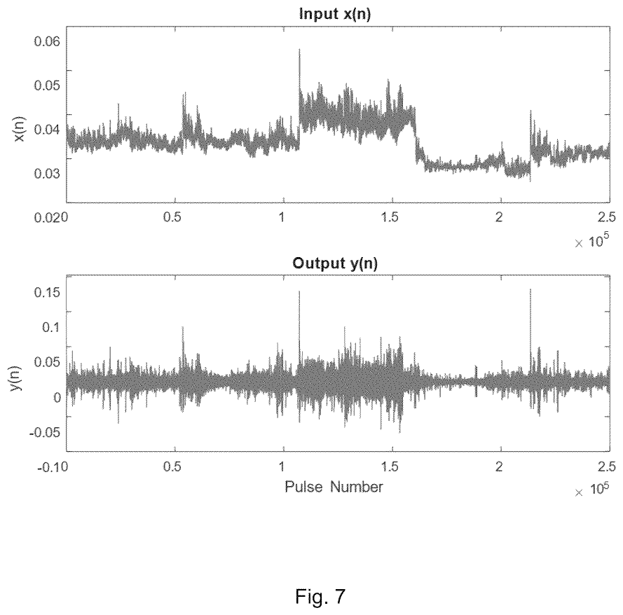

FIG. 7 shows a comparison between input sequence x(n) and a resulting output sequence y(n) as time-series, for a set of feedback parameters. The resulting output sequence is an output noise distribution. The voltage pulses used may be 1V every 100 μs. Each sample of the output y(n) represents a sample from a distribution whose mean and variance can be tuned (by, e.g., tuning means 180) using the feedback parameters. The resulting distributions can be tuned by altering the feedback parameters. The feedback parameters may be one or more statistical characteristics which may comprise at least one or more of: an average value; an offset; a variance; a distribution; and a bias. Closed-loop gain controls the variance of the resulting distributions and the reference input t(n) sets the mean value. The circuits ability to eliminate low frequency drift and amplify the noise is apparent.

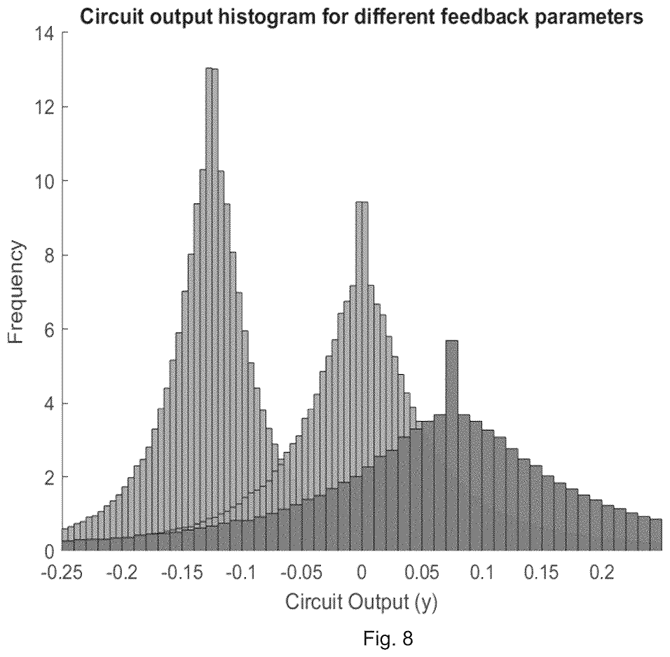

FIG. 8 shows experimentally generated distributions of output y(n) for three different parameter sets, wherein 250k pulses are shown for each set of feedback parameters, thereby demonstrating the ability of the system to tune mean and variances.

In complex statistical models, samples are generated from resulting distributions that are not analytically tractable. Bayesian inference can be used, in conjunction with the apparatus 100 and/or circuit 600, to efficiently sample a desired distribution. Bayesian inference may be described as a method of statistical inference in which Bayes' theorem is used to update the probability for a hypothesis as more evidence or information becomes available. Bayesian inference uses prior knowledge, in the form of a prior distribution, in order to estimate posterior probabilities. These samples can be used, via a Monte-Carlo process, for computing various statistical measures of the desired distribution. Monte Carlo methods, or Monte Carlo experiments, may be described as a class of computational algorithms that rely on repeated random sampling to obtain numerical results. In other words, Monte Carlo methods use randomness to solve problems that might be deterministic in principle.

To sample from a Memristive Distribution Generator (MDG) or a plurality of MDGs, a system may have M distinct hardware MDGs, and a corresponding output sample βᵢ, where i=1, 2, . . . , M. The vector β=[β₁, β₂, . . . , β_{M}] collectively represents a joint sample from each of these MDGs as shown in FIG. 6, where there is a sequence of “Distribution Conditioning” circuits. This may be described as k^{th} circuits n^{th} output, yₖ(n) as

$${β}_{k}^{( n )} .$$

In a Bayesian inference framework, samples are drawn from a posterior distribution p(β|data) to perform inference, so a circuit for each parameter to be computed is required. First, N samples β⁽¹⁾, β⁽²⁾, . . . , β^{(N)} are drawn that are distributed according to the prior distribution p(β):

β⁽¹⁾, β⁽²⁾, . . . , β^{(N)}~p(β) (Equation 2)

The prior distribution p(β) is a key part of Bayesian inference and represents information about an uncertain parameter that is combined with the probability distribution of new data to result in the posterior distribution p (|data), which in turn is used for future inferences and decisions.

In the case where each element βi in β is assumed to be independent of the other elements, the joint prior distribution p(β) simplifies to the product of individual priors:

$$p ( β ) = p ( {β}_{1} , {β}_{2} , ... , {β}_{M} ) = {\prod }_{i = 1}^{M} p ( {β}_{i} ) \qquad ( Equation 3 )$$

Each p(βᵢ) represents the prior distribution of βᵢ, and depends on the characteristics of the respective memristor and the parameters of the respective feedback circuit.

In the process of using M MDGs, each sampling operation produces a sample β from the joint distribution p(β), covering a plurality of the MDGs (or all of the MDGs). The properties of the distribution p(β|data), which represents the distribution of β after training, conditioned on a given dataset and a specific observation/noise model are yet to be determined. Bayes' theorem provides:

$$p ( β \vert data ) = \frac{p ( β \vert data ) \cdot p ( β )}{p ( data )} \qquad ( Equation 4 )$$

In Equation 4, p(β|data) is the posterior distribution, p(β|data) is the likelihood function of observing the data given β, p(β) is the prior distribution of β, and p(data)=Σ_{β}p (data|β)·p(β) is evidence that serves as a normalisation constant for the posterior distribution.

Directly using Equation 4 to compute the posterior distribution may be unfeasible as the parametric forms of these distributions are generally not known. Hence, the samples generated by the hardware MDG to perform Monte-Carlo sampling of the intended posterior distribution p(β|data) are directly used.

Importance sampling is a technique used in the Monte-Carlo sampling of a target distribution of interest when direct sampling is computationally expensive. The approach introduces a proposal distribution and a weight that links each sample of the proposal distribution to a sample of the target distribution.

This may be implemented using the hardware MDG, which in turn generates the proposal distributions and facilitates the Monte-Carlo process through the ability to tune the proposal distributions.

Weighted sampling may be used. Given samples from two probability mass functions: m(β) and q(β), a weight wᵢ can be defined. The mass functions are related in Equation 5:

$${w}_{i} = \frac{m ( {β}^{( i )} )}{q ( {β}^{( i )} )} \qquad ( Equation 5 )$$

The expectation of an f(β) where β is distributed according to m(β) may then be calculated using samples of β drawn from distribution q(β) and the weights:

$${E}_{m ( β )} [ f ( β ) ] = {\sum }_{β} f ( β ) \cdot m ( β ) = {E}_{q ( β )} [ {w}_{β} f ( β ) ] \qquad ( Equation 6 )$$

The samples generated by the hardware MDG are used to sample the desired distribution. By setting q(β)=p(β) (Eq.3), m(β)=p (β|data) and invoking Bayes' theorem (Equation 4), Equation 7 is attained for a given sample β⁽ⁱ⁾:

$${w}_{i} = \frac{p ( {β}^{( i )} \vert data )}{p ( {β}^{( i )} )} = \frac{p ( data \vert {β}^{( i )} )}{p ( data )} \qquad ( Equation 7 )$$

Equation 7 shows that a likelihood function, divided by a normalisation constant, can be described as a weight. This weight links the posterior distribution to the MDG generated priors. This simplification allows the computation of the weights up to a normalisation constant, directly from the likelihood function, without knowing the exact distribution of the hardware MDG.

By substitution, Equation 7 may be shown as:

$${E}_{p ( β )} [ w ( β ) ] = {\sum }_{β} {w}_{β} \cdot p ( β ) = 1 \approx {\sum }_{i = 1}^{N} {w}_{i} .$$

Computing the normalisation constant may not be necessary, as an estimator can be constructed that does not require calculating p (data), as shown in Equation 8:

$${E}_{p ( β \vert data )} [ f ( β ) ] \approx \frac{\frac{1}{N} {\sum }_{i = 1}^{N} {w}_{i} \cdot f ( {β}^{( i )} )}{\frac{1}{N} {\sum }_{i = 1}^{N} {w}_{i}} \approx {\sum }_{i = 1}^{N} {w}_{i}^{( norm )} \cdot f ( {β}^{( i )} ) \qquad ( Equation 8 )$$

When β⁽ⁱ⁾ are drawn from p(β) and

$${w}_{i}^{( norm )}$$

are weights that no longer depend on p(data), Equation 9 is generated:

$${w}_{i}^{( norm )} = \frac{p ( data \vert {β}^{( i )} )}{{\sum }_{j = 1}^{N} p ( data \vert {β}^{( j )} )} \qquad ( Equation 9 )$$

Equation 9 shows that it may be unnecessary to calculate the unnormalised weights (as shown in Equation 7) and instead for the normalised weights used in the estimator (as shown in Equation 8), it is sufficient to define the unnormalised weights simply as:

wᵢ=p(data|β⁽ⁱ⁾) (Equation 10)

Selecting a proposal distribution, generated through hardware, that approximates the true posterior, is important to improve estimation efficiency and accuracy, thereby improving the success of importance sampling. This can be achieved by adaptively tuning parameters of each individual MDG, to continually refine the approximation. To guide this tuning, the Effective Sample Size (ESS), calculated as

$$ESS = 1 / {\sum }_{i = 1}^{N} {( {w}_{i}^{( norm )} )}^{2} ,$$

is monitored. Iterative adjustments to the circuits parameters are made when the ESS is low, ensuring a well-matched proposal and posterior distribution.

In an example, the parameters of a 1-D regression can be estimated using the present application, wherein two or more MDG circuits based on Pt/TiO2/Pt memristors are used. The example applies a plurality of pulses, measures the resulting random current response, processes the samples in the feedback circuit and transmits the output of the circuit, via a serial port, to a computer for analysis. The computer may comprise a Python script. The Python script of this example additionally contains a dataset and is responsible for computing the approximation of the posterior distribution, based on each incoming sample β⁽ⁱ⁾ from the hardware.

Linear regression can be modelled as the relationship between a dependent variable y and an independent variable x, in the presence of white noise e as follows:

y=β₀+β1+∈, where ∈~ [symbol] (0,σ²) (Equation 11)

The likelihood function for a complete set of K datapoints (xⱼ, yⱼ), given the i^{th} sample

$${β}^{( i )} = [ {β}_{0}^{( i )} , {β}_{1}^{( i )} ] can be :$$

$$p ( data \vert {β}^{( i )} ) {\prod }_{j = 1}^{K} exp ( - \frac{{( {y}_{j} - {β}_{0}^{( i )} - {β}_{1}^{( i )} {x}_{j} )}^{2}}{2 {σ}^{2}} \qquad ( Equation 12 )$$

At the beginning of a first iteration, the Python script initialises a feedback parameter for all MDG circuits, resulting in a first guess for the optimum p(β). Subsequently, the system requests a sample β⁽ⁱ⁾ from the hardware. The script then calculates the likelihood over the entire dataset, which corresponds to the unnormalized weight wᵢ=p(data|β⁽ⁱ⁾). This process is repeated for a predefined/preset number of iterations (or a predefined/preset plurality of iterations), keeping the feedback parameters constant (or the same). The set of normalised weights

$${w}_{i}^{( norm )}$$

are determined next. The quality of the posterior estimate (i.e., the output) is evaluated using ESS, after the specified number of iterations. If the output is not within a threshold, the script instructs the hardware to adjust the feedback network parameters, thereby changing the resulting distribution. The script then obtains the predefined number of samples again by repeating the process for the predefined number of iterations, and the loop continues until a satisfactory ESS value is reached. When the output (i.e., the estimate) is within the threshold, the samples of the posterior are used to examine its distribution and to estimate desired moments of the model parameters using Equation 8.

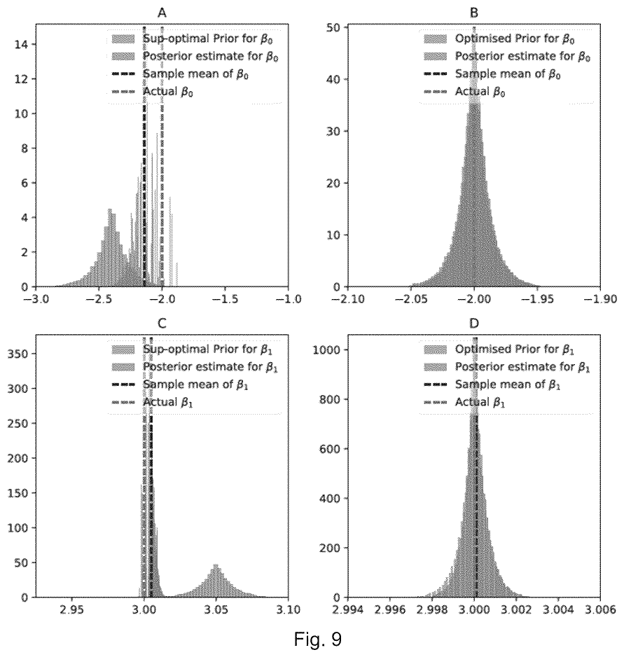

FIGS. 9A and 9C show experimental results when the MDG are producing sub-optimally distributed samples. FIGS. 9B and 9D show experimental results when the hardware has been configured to produce samples that coincide better with the posterior distributions. The parameters underlying values are β₀=−2 and β₁=3 and the dataset is corrupted with noise ∈~ [symbol] (0, σ²=1). After running the hardware for a sufficient number of iterations, the MDG are tuned so that they generate samples from a distribution that perform an efficient and accurate Monte-Carlo sampling of the model parameter posterior distributions and hence sample means.

Hence, the read noise of a memristor can be harnessed using a feedback circuit, that can generate distributions of tunable characteristics. The apparatus disclosed herein can be used to facilitate a Monte-Carlo I sampling engine and within a parameter estimation problem of a noisy dataset via Bayesian regression (when, for example, two memristors are used in the apparatus). In other words, the apparatus facilitates Monte-Carlo sampling within a Bayesian inference framework and/or is configured to perform Monte-Carlo sampling within a Bayesian inference framework. In this manner, the method performs Monte-Carlo sampling within a Bayesian inference framework.

Stochastic pulsed signals may be used to control mixed-signal analogue and digital circuits. For example, the output frequency of a fractional Phase Locked Loop may be controlled by a stochastic pulse sequence. In other examples, an output of a sigma-delta modulator used in high resolution (i.e., big bit number) ADCs is a stochastic pulse sequence. The pulse sequences in some examples have undesired spectral features that the output of the apparatus of the present disclosure does not have. Therefore, the apparatus disclosed herein may be a spectrally superior competitor (or building block) for sigma-delta modulators and fractional Phase Locked Loops. More generally, stochastic bit streams can be used as dither noise in decision-making circuits.

The present application uses a variable comparison threshold to compare the instantaneous value of the memristor resistance, not a fixed comparison threshold. In this manner, comparing pairs of successive samples is equivalent to differentiation (in a mathematical sense) and hence it is robust to memristor drift over time. The apparatus and method extracts randomness from the memristor without altering its underlying conductance value significantly. By applying only non-intrusive pulses, the present application is able to amplify and extract the randomness, thereby preserving the underlying memristor conductance value, and allowing it to be used simultaneously as a memory element.

In addition, the disclosed system and method does not require volatile memristors, nor does it specify any particular material system or doping profile. Diffusive and volatile memristors are of limited use in CMOS memory applications, hence a TRNG needs to be build using non-volatile memristors that will be part of future CMOS systems. The present application demonstrates functionality using memristors that are being used for CMOS memory applications.

Furthermore, the disclosed system and method is capable of controlling a mean and variance of the output analogue random signal, by controlling gain and the offset of the feedback loop, enabling the control of the characteristics of the analogue distributions being output from the apparatus.

It is to be understood that the above description is intended to be illustrative, and not restrictive. Many other implementations will be apparent to those of skill in the art upon reading and understanding the above description. Although the present disclosure has been described with reference to specific example implementations, it will be recognized that the disclosure is not limited to the implementations described but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. An apparatus for generating random numbers, the apparatus comprising one or more bit stream generators, wherein each bit stream generator comprises:
a memristor;
a pulse generator configured to:
generate a plurality of pulses; and
apply the plurality of pulses through the memristor to generate an output comprising a plurality of output pulses; and
a comparison means configured to:
compare a first sample of the pulsed output with a second sample of the pulsed output; and
output, based on the first comparison, information indicative of a randomly generated bit of a random bit stream.

2. The apparatus of claim 1, wherein the comparison means is further configured to:
compare the information indicative of a randomly generated bit of a random bit stream with a comparison threshold or an input threshold; and
output, based on the second comparison, tuned information indicative of a randomly generated bit of a random bit stream.

3. The apparatus of claim 2, further comprising a feedback loop configured to generate the comparison threshold by modifying the tuned information indicative of a randomly generated bit of a random bit stream.

4. The apparatus of claim 2, wherein each bit stream generator further comprises a tuning means comprising one or more analogue switches configured to control one or more statistical characteristics of the random bit stream using the comparison threshold or an input threshold.

5. The apparatus of claim 4, wherein the one or more statistical characteristics may comprise at least one or more of: an average value; an offset; a variance; a distribution; and a bias.

6. The apparatus of claim 1, wherein the comparison means comprises a clocked comparator.

7. The apparatus of any of claim 1, wherein the first sample comprises a sampled plurality of output pulses, and each bit stream generator further comprises a delaying means configured to generate the second sample by performing computation on the sampled plurality of output pulses.

8. The apparatus of claim 1, wherein the first sample comprises a sampled plurality of output pulses, and each bit stream generator further comprises a delaying means configured to generate the second sample by introducing a delay to the sampled plurality of output pulses.

9. The apparatus of claim 8, wherein the delaying means comprises an analogue polyphase filter, wherein the analogue polyphase filter optionally comprises a differentiation means.

10. The apparatus of claim 8, wherein the delaying means comprises a passive element configured and positioned to generate the second sample by storing the sampled plurality of output pulses, thereby introducing a delay.

11. The apparatus of any claim 10, wherein:
the passive element is a capacitor;
the response of the memristor is a current; and
each bit stream generator further comprises a sense resistor configured to sense a variation in the current of the memristor as a voltage.

12. The apparatus of claim 7, wherein the delaying means comprises the comparison means.

13. The apparatus of claim 7, wherein the delaying means is configured to subtract the second sample from the first sample.

14. The apparatus of claim 1, wherein the first and second samples are sensing pulses, and the pulse generator is further configured to generate a plurality of stressing pulses, wherein each sensing pulse is preceded by a stressing pulse, and wherein optionally the plurality of stressing pulses are narrow voltage pulses.

15. The apparatus of claim 1, wherein the pulse generator is configured to control an amplitude of the stressing pulses.

16. The apparatus of claim 1, wherein each bit stream generator comprises only one memristor.

17. The apparatus of claim 1, wherein the plurality of output pulses are based on a response of the memristor through which the plurality of pulses are applied.

18. The apparatus of claim 1, wherein each bit stream generator outputs information indicative of a plurality of randomly generated bits to form the random bit stream.

19. The apparatus of claim 1, wherein the apparatus is configured to perform Monte-Carlo sampling within a Bayesian inference framework.

20. A method for generating random numbers comprising:
generating, by a pulse generator, a plurality of pulses;
applying the plurality of pulses to a memristor;
generating, by the memristor, an output comprising a plurality of output pulses;
comparing, by a comparison means, a first sample of the pulsed output with a second sample of the pulsed output; and
outputting, by the comparison means, information indicative of a randomly generated bit of a random bit stream based on the first comparison.

21. The method of claim 20, further comprising:
comparing, by the comparison means, the information indicative of a randomly generated bit of a random bit stream with a comparison threshold; and
outputting, by the comparison means, tuned information indicative of a randomly generated bit of a random bit stream based on the second comparison, and optionally
wherein the comparison means comprises a clocked comparator.

22. The method of claim 21, further comprising:
generating the comparison threshold by modifying, by a feedback loop, the tuned information indicative of a randomly generated bit of a random bit stream.

23. The method of claim 20, further comprising:
controlling, by one or more analogue switches, one or more statistical characteristics of the random bit stream using a or the comparison threshold or an input threshold,
wherein the one or more statistical characteristics optionally comprise at least one or more of:
an average value;
an offset;
a variance;
a distribution; and
a bias.

24. The method of claim 20, wherein the first sample comprises a sampled plurality of output pulses and the method further comprises:
generating, by a delaying means, the second sample by introducing a delay to the sampled plurality of output pulses; and optionally
storing, by the delaying means, the sampled plurality of output pulses to generate the second sample and introduce a or the delay to the sampled plurality of output pulses.

25. The method of claim 24, wherein the delaying means comprises at least one or more of:
the comparison means;
an analogue polyphase filter or a differentiation means; and
a passive element.

26. The method of any of claim 20, wherein the first and second samples are sensing pulses and the method further comprises:
generating a plurality of stressing pulses, by the pulse generator, to precede the first and second samples of the pulsed output, wherein the plurality of stressing pulses are optionally narrow voltage pulses; and optionally
controlling, by the pulse generator, an amplitude of the plurality of stressing pulses.

27. The method of claim 20, further comprising performing Monte-Carlo sampling within a Bayesian inference framework.
